(19) United States
(12) Patent Application Publication
(10) Pub. No.: US 2016/0003299 A1
(43) Pub. Date: Jan. 7, 2016

(54) ROLLER BEARING AND METHOD FOR PRODUCING A ROLLER BEARING

(71) Applicant: SCHAEFFLER TECHNOLOGIES AG & CO. KG, Herzogenaurach (DE)

(72) Inventor: Tanja Meyer, Schweinfurt (DE)

(73) Assignee: SCHAEFFLER TECHNOLOGIES AG & CO. KG, Herzogenaurach (DE)

(21) Appl. No.: 14/771,620

(22) PCT Filed: Feb. 26, 2014
(86) PCT No.: PCT/DE2014/200092

§ 371 Date: Aug. 31, 2015

(30) Foreign Application Priority Data
Mar. 14, 2013 (DE) 10 2013 204 412.7

(51) Int. Cl. F16C 33/58; F16C 43/06; B23P 15/00; F16C 19/08

(52) U.S. Cl. CPC F16C 33/581; F16C 19/08; F16C 43/06; F16C 33/58; B23P 15/003

(57) ABSTRACT

A roller bearing (2), in particular for a rotary connection in a wind turbine, including an outer ring (8), an intermediate ring (10) and an inner ring (12), wherein at least one layer of rolling bodies (14) is arranged both between the outer ring (8) and the intermediate ring (10) and between the intermediate ring (10) and the inner ring (12) such that the outer ring (8) is rotatably mounted against the intermediate ring (10) on one side and the intermediate ring (10) is rotatably mounted against the inner ring (12) on the other side, and wherein the outer ring (8) and/or the inner ring (12) is connected to a toothed segment (24), which covers one end of a filling channel (16) in the outer ring (8) or inner ring (12) respectively.

### FIELD OF THE INVENTION

The invention relates to a roller bearing, in particular, for a rotary joint in a wind turbine, comprising an outer ring, an intermediate ring, and an inner ring, wherein at least one layer with rolling bodies is arranged between the outer ring and the intermediate ring and also between the intermediate ring and the inner ring, so that the outer ring is supported so that it can rotate relative to the intermediate ring on one side and the intermediate ring is supported so that it can rotate relative to the inner ring on the other side. In addition, the invention relates to a method for producing a corresponding roller bearing.

### BACKGROUND

For the rotary joints in many modern wind turbines, so-called large roller bearings are used, whose dimensions are in the range of meters. Such large roller bearings are to allow not only rotational movements for the lowest possible friction losses and low wear, they must also usually withstand very high loads, especially also the effect of high bending forces. In addition, large roller bearings cause rather high production costs, because production equipment like that typically used for mass production is not available.

### SUMMARY

Starting from this background, the invention is based on the objective of providing an advantageously shaped roller bearing and a method for producing a corresponding roller bearing.

The objective related to the roller bearing is achieved according to one or more aspects of the invention. The description and claims include improvements that are partially advantageous and partially inventive in of themselves.

A roller bearing presented here is, in particular, a large roller bearing for a rotary joint in a wind turbine and preferably a large roller bearing with a diameter in the range of 0.5 m to 4 m. Here, the roller bearing is an outer ring, an intermediate ring, and an inner ring, wherein at least one layer with rolling bodies is arranged between the outer ring and the intermediate ring and also between the intermediate ring and the inner ring, so that the outer ring is supported so that it can rotate relative to the intermediate ring on one side and the intermediate ring is supported so that it can rotate relative to the inner ring on the other side. In addition, the outer ring and/or the inner ring is connected to a toothed segment that covers one end of a filling channel in the outer ring or inner ring. The toothed segment is here provided as part of an adjustment device to which a servomotor is engaged, so that, in this way, a rotary joint is realized with a controllable rotational position. Such a rotary joint is used, for example, in a wind turbine, to be able to adjust the rotational position of the so-called nacelle relative to the tower or else for controlling the blade position of the rotor blades relative to the hub.

Due to the selected shape of the roller bearing, a relatively simple production of corresponding roller bearings is guaranteed. In this way, preferably first the outer ring, the intermediate ring, the inner ring, the rolling bodies, and the toothed segment are each produced in separate production processes and then assembled in the scope of an assembly process. In the scope of this assembly process, the filling channel is used for introducing the rolling bodies into the intermediate space between the outer ring or the inner ring and the intermediate ring. Then, in a subsequent assembly process step, the toothed segment is connected to the outer ring or the inner ring, wherein the filling channel is covered and thus closed. Compared with the prior art, according to which the teeth are not arranged on a separate toothed segment, but instead are formed directly on the outer ring or inner ring, the solution proposed here offers the advantage that the filling channel typically needed for the production of the roller bearing does not have to be guided through the teeth. Because there are very high qualitative demands just on the teeth, a corresponding realization of the filling channel through the teeth tends to be unfavorable.

A variant of the roller bearing is also advantageous in which at least one layer with rolling bodies is arranged between the outer ring and the intermediate ring concentric and coaxial to at least one layer with rolling bodies between the intermediate ring and the inner ring. Thus, at least two layers with rolling bodies are arranged offset relative to each other in the radial direction, which increases the stiffness of the roller bearing.

In one advantageous improvement, the roller bearing is also shaped such that the layers with roller bearings each have crossing pressure lines. A corresponding support of rolling bodies with crossing pressure lines is described in detail in WO 2010/037370 A1, which goes back to the applicant and whose contents this publication herewith explicitly incorporates. The variants specified in that publication for supporting rolling bodies with crossing pressure lines are basically suitable for a roller bearing proposed here and are used accordingly for the roller bearing depending on the purpose of the application.

Here, a variant is preferred in which at least one layer with rolling bodies is formed by balls in a four-point bearing. For the case that roller bearings are used for a rotary joint of a wind turbine, a construction is also preferred in which each layer with rolling bodies is formed by balls in a four point support.

It is also preferred if the filling channel is provided with a filler. In this way it is not only prevented that individual rolling bodies can come out of their provided movement track, but care can also be taken that the corresponding outer ring or inner ring can be loaded in the area of the filling channel approximately the same as in the other areas. The filler is here introduced in a separate production process into the filling channel, after which the rolling bodies are introduced into the corresponding intermediate area between the outer ring or inner ring and intermediate ring.

Preferably, the toothed segment is also formed as a ring body that preferably has teeth extending over an angular area <360°. The angular area over which the teeth extend is here typically adapted to the corresponding purpose of the application. If adjustability over an angular area of 180° is desired, then it is sufficient to form the teeth over an angular area that is slightly greater than 180°.

A construction of the roller bearing is also advantageous in which the toothed segment is fastened by means of a threaded connection on the outer ring or inner ring. Due to such a detachable fastening, it is possible to exchange the toothed segment individually as needed, that is, if there is damage. Accordingly, in such a case, the entire roller bearing does not have to be replaced, but instead only the actually damaged part, namely the toothed segment.

The stated objective of providing an advantageous method for producing a corresponding roller bearing is solved by a method claim. The method is here used, in particular, for producing a roller bearing of one of the constructions named above, wherein a corresponding roller bearing comprises an outer ring, an intermediate ring, and an inner ring. In the scope of the method, there is at least one layer with rolling bodies between each of the outer ring and the intermediate ring and between the intermediate ring and the inner ring, so that the outer ring is supported so that it can rotate relative to the intermediate ring on one side and the intermediate ring is supported so that it can rotate relative to the inner ring on the other side in the final assembly state. Here, for the arrangement of at least one layer with rolling bodies, a filling channel is machined into the outer ring and/or into the inner ring, through which the rolling bodies are inserted in the scope of an assembly process step into the intermediate space between the outer ring or the inner ring and the intermediate ring. In a later process step, the filling channel is provided with a filler and thus the outer ring or the inner ring is connected to a toothed segment, wherein the toothed segment covers one end of the filling channel provided with the filler.

### BRIEF DESCRIPTION OF THE DRAWINGS

Embodiments of the invention are explained in more detail below with reference to a schematic drawing. Shown are:

FIG. 1 in a side view, a roller bearing with an inner ring and with a toothed segment,

FIG. 2 in a sectional representation, the roller bearing,

FIG. 3 in a sectional representation, the toothed segment,

FIG. 4 in a side view, the inner ring with the toothed segment,

FIG. 5 in a side view, a cut-out of the inner ring with an alternative toothed segment, and

FIG. 6 in a side view, a cut-out of a rotary joint with the roller bearing.

Parts corresponding to each other are each provided with the same reference symbols in all of the figures.

### DETAILED DESCRIPTION OF THE PREFERRED EMBODIMENTS

A roller bearing 2 described below as an example is part of a rotary joint between a rotor blade 4 and a rotor hub 6 of a wind turbine, in which the rotational position of the rotor blade 4 relative to the rotor hub 6 is specified by means of a not-shown servomotor and gear drive.

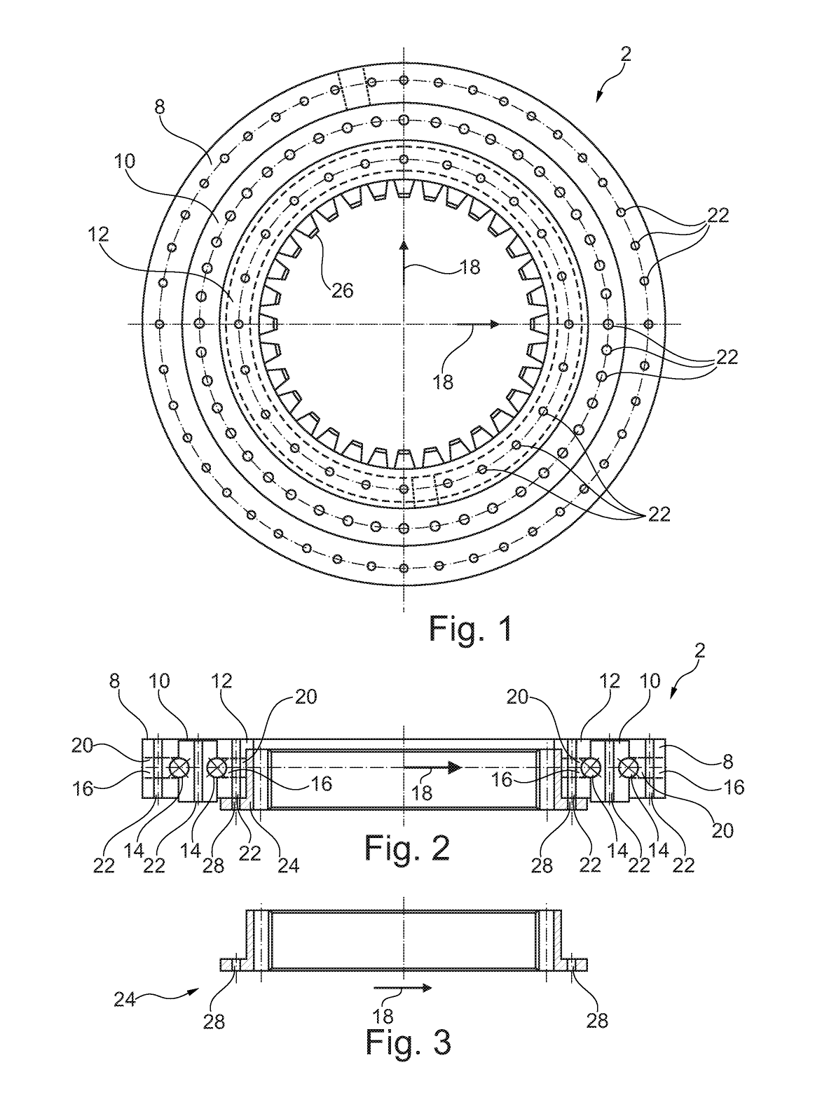

The roller bearing 2 that is shown in FIG. 1 in a top view and in FIG. 2 in a sectional representation is here constructed as a so-called large roller bearing and has a diameter of 1.5 m. It comprises an outer ring 8, an intermediate ring 10, and an inner ring 12, wherein there is a layer with rolling bodies between each of the outer ring 8 and the intermediate ring 10 on one side and between the intermediate ring 10 and the inner ring 12 on the other side, so that the outer ring 8 is supported so that it can rotate relative to the intermediate ring 10 and the intermediate ring 10 is supported so that it can rotate relative to the inner ring 12.

Here, each layer with rolling bodies is formed by balls 14 that are supported in a so-called four point support according to a known principle.

For positioning the balls 14 between the outer ring 8 and the intermediate ring 10 on one side and between the intermediate ring 10 and the inner ring 12 on the other side, both the outer ring 8 and also the inner ring 12 each have two filling channels 16 that pass completely through the corresponding rings 8, 12 in the radial direction 18. Each filling channel 16 is provided with a filler 20, which prevents the balls 14 from breaking out of their provided tracks into the filling channels 16.

In addition, both the outer ring 8 and also the inner ring 12 have several fastening holes 22 that are arranged distributed according to a kind of equal division over the circumference and through which bolts are guided in the final assembly state for connecting the roller bearing 2 to the rotor blade 4. The intermediate ring 10 is likewise provided with several fastening holes 22 that are arranged distributed according to a kind of equal division over the circumference and through which screws are also guided in the final assembly state, but for connecting the roller bearing 2 to the rotor hub 6.

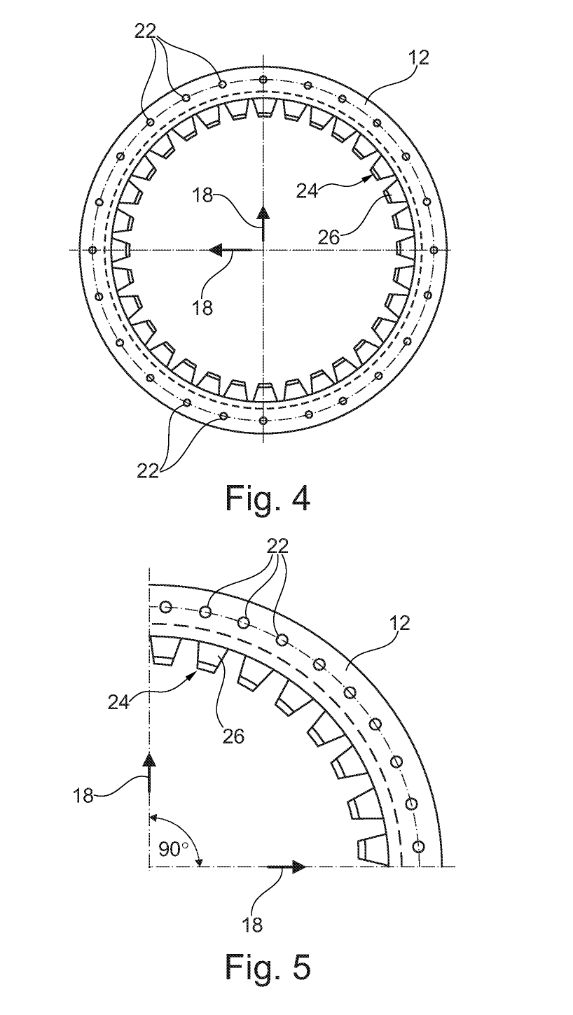

As can be seen from FIG. 2, the roller bearing 2 also comprises a toothed segment 24 that is shown separately in FIG. 3. Each toothed segment 24 is formed in one variant as a ring body with teeth 26 extending over the entire circumference, that is, over 360°. This variant is shown in FIG. 4, wherein the toothed segment 24 is shown in the figure together with the inner ring 12. Alternatively, the toothed segment 24 is given by a ring segment, wherein, in this case, the teeth 26 cover only an angular area <360°, that is, for example, an angular area of 90°. This variant is sketched in FIG. 5.

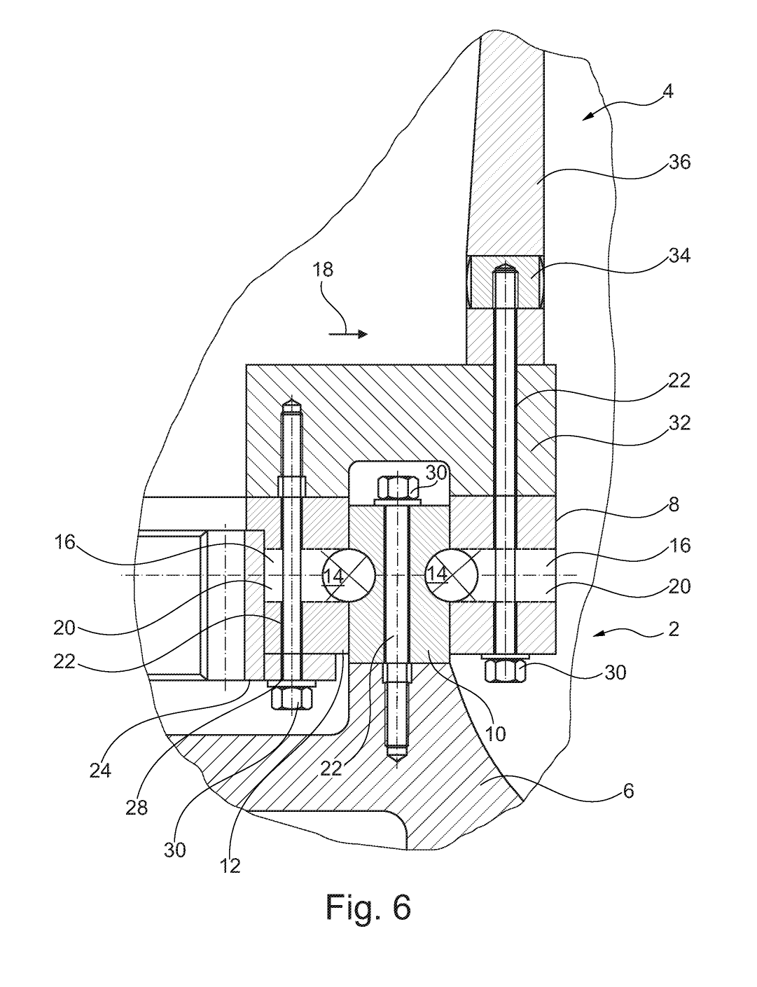

The toothed segment 24 is fastened on the inner ring 12, as shown in FIG. 6, also by means of a threaded connection. For this purpose, the toothed segment 24 has several mounting holes 28 that are arranged distributed over its circumference and are arranged such that these align with the fastening holes 22 in the inner ring 12. In the final assembly state, hexagon head bolts 30 are then guided through the assembly holes 28 such that each hexagon head bolt 30 passes through both an assembly hole 28 and also a fastening hole 22 in the inner ring 12 and also engages in the blade root 32 of the rotor blade 4 manufactured from steel so that by means of the corresponding hexagon head bolts 30, both the toothed segment 24 is connected to the inner ring 12 and also the inner ring 12 is connected to the rotor blade 4.

In the opposite direction, hexagon head bolts 30 are guided through fastening holes 22 in the intermediate ring 10, so that these pass through the intermediate ring 10 and engage in the rotor hub 6. In this way, the intermediate ring 10 is screwed to the rotor hub 6.

To connect the outer ring 8 to the rotor blade 4, hexagon head bolts 30 are finally passed through the outer ring 8 and through the blade root 32 so that these engage in threaded cross bolts 34 made from steel that are positioned in the wall 36 of the rotor blade 4 made from glass fiber-reinforced plastic.

The invention is not limited to the previously described embodiment. Instead, other variants of the invention can also be derived by someone skilled in the art without leaving the subject matter of the invention. In particular, all of the individual features described in connection with the embodiment can also be combined with each other in other ways, without leaving the subject matter of the invention.

### LIST OF REFERENCE NUMBERS

2 Roller bearing
4 Rotor blade
6 Rotor hub
8 Outer ring
10 Intermediate ring
12 Inner ring
14 Ball
16 Filling channel
18 Radial direction
20 Filler
22 Fastening hole
24 Toothed segment
26 Teeth
28 Mounting hole
30 Hexagon head bolt
32 Blade root
24 Threaded cross bolt
36 Wall

1. A roller bearing for a rotary joint in a wind turbine, comprising an outer ring, an intermediate ring, and an inner ring, at least one layer with rolling bodies between each of the outer ring and the intermediate ring and between the intermediate ring and the inner ring, so that the outer ring is rotatably supported relative to the intermediate ring on one side and the intermediate ring is rotatably supported relative to the inner ring on the other side, and at least one of the outer ring or the inner ring is connected to a toothed segment that covers one end of a filling channel in the outer ring or the inner ring.

2. The roller bearing according to claim 1, wherein at least one of the layers with the rolling bodies is arranged between the outer ring and the intermediate ring concentric and coaxial to at least one of the layers with the rolling bodies between the intermediate ring and the inner ring.

3. The roller bearing according to claim 1, wherein the layers with the rolling bodies each have crossing pressure lines.

4. The roller bearing according to claim 1, wherein at least one of the layers with the rolling bodies is formed by balls in a four point support.

5. The roller bearing according to claim 1, wherein each of the layers with the rolling bodies is formed by balls in a four point support.

6. The roller bearing according to claim 1, wherein the filling channel is provided with a filler.

7. The roller bearing according to claim 1, wherein the toothed segment is formed as a ring body.

8. The roller bearing according to claim 1, wherein teeth of the toothed segment extend over an angular area less than 360°.

9. The roller bearing according to claim 1, wherein the toothed segment is fastened by a threaded connection on the outer ring or the inner ring.

10. A method for the production of a roller bearing according to claim 1, comprising the outer ring, the intermediate ring, and the inner ring, the method comprising
providing the at least one layer with the rolling bodies between each of the outer ring and the intermediate ring and between the intermediate ring and the inner ring, so that the outer ring is rotatably supported relative to the intermediate ring on one side and the intermediate ring is rotatably supported relative to the inner ring on the other side in a final assembly state,
for the arrangement of at least one layer with rolling bodies, machining a filling channel in at least one of the outer ring or the inner ring and inserting the rolling bodies through the filling channel into the intermediate space between the outer ring or the inner ring and the intermediate ring,
providing the filling channel with a filler, and
connecting the outer ring or the inner ring to the toothed segment that covers one end of the filling channel.
